(19) United States
(12) Patent Application Publication
(10) Pub. No.: US 2010/0207539 A1
(43) Pub. Date: Aug. 19, 2010

(54) CIRCUIT FOR CONTROLLING AN OPERATING DEVICE FOR A LIGHT APPLICATION, OPERATING DEVICE AND METHOD FOR OPERATION OF THE CIRCUIT

(75) Inventor: Helmut Haeusser, Traunreut (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/704,546

(22) Filed: Feb. 12, 2010

(30) Foreign Application Priority Data
Feb. 18, 2009 (DE) 10 2009 009 535.7

(51) Int. Cl. H05B 37/02

(52) U.S. Cl. 315/291

(57) ABSTRACT

A circuit for controlling an operating device for a light application is provided. The circuit may include a galvanically isolated transmitter configured to receive an applied control signal; and a power section configured to be activated by the galvanically isolated transmitter as a function of the control signal.

### CROSS-REFERENCE TO RELATED APPLICATION

This application claims priority to German Patent Application Serial No. 10 2009 009 535.7, which was filed Feb. 18, 2009, and is incorporated herein by reference in its entirety.

### TECHNICAL FIELD

Various embodiments relate to a circuit for controlling an operating device for a light application, to an operating device and to a method for operation of the circuit.

### BACKGROUND

Lights, ballasts and other devices which are relevant for light applications are often controlled via a bus system (for example a DALI bus system).

The “Digital Addressable Lighting Interface” (DALI) is a control protocol for controlling digital lighting equipment in buildings (for example electronic transformers, electronic ballasts, electronic power dimmers, etc.). Every operating device which has a DALI interface can be controlled individually by short DALI addresses. A DALI controller or a DALI gateway can check the status of light sources and of operating devices of a light, and/or can set the state, by means of a bidirectional data interchange.

In this case, one disadvantage is that the operating devices nevertheless consume electrical power when they are inactive.

### SUMMARY

A circuit for controlling an operating device for a light application is provided. The circuit may include a galvanically isolated transmitter configured to receive an applied control signal; and a power section configured to be activated by the galvanically isolated transmitter as a function of the control signal.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows an embodiment of an operating circuit including a supply unit, a control and a power section;

FIG. 2 shows an alternative circuit for the operating circuit shown in FIG. 1;

FIG. 3 shows an overall block diagram of an operating device which is controlled via a DALI bus; and

FIG. 4 shows, by way of example, one possible implementation of the operating circuit shown in FIG. 3.

### DESCRIPTION

The following detailed description refers to the accompanying drawings that show, by way of illustration, specific details and embodiments in which the invention may be practiced.

In the following text, the DALI bus is used as one example of a bus system for use in conjunction with and for controlling light applications. Other bus systems may be used in a corresponding manner in alternative embodiments.

Various operating devices, for example an electronic ballast, a lamp or a light, a sensor, an actuator or combinations of the abovementioned, may be controlled via the bus system. It is also possible for the operating device to use the bus system to transmit information to at least one further operating device and/or to a central controller.

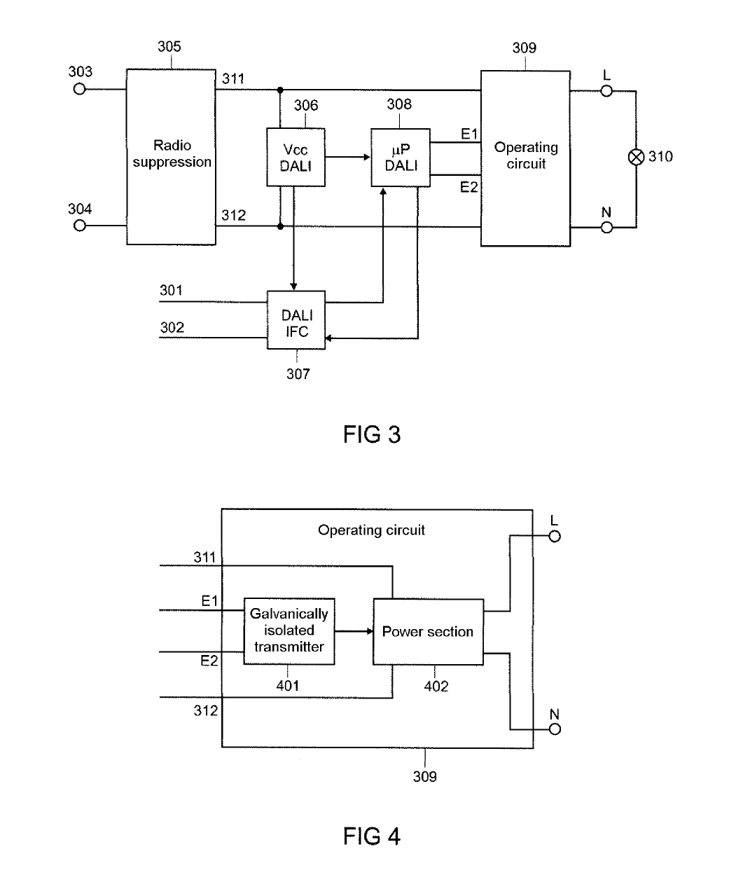

FIG. 3 shows an overall block diagram of an operating device which is controlled via a DALI bus.

The operating device is connected to a power supply via radio suppression 305, by means of the connections 303 and 304. Via its outputs 311 and 312, the radio suppression 305 prevents emission of radio interference signals from the operating device. The operating device furthermore has a DALI interface 307, which is connected to DALI lines 301 and 302. The DALI interface 307 is fed from a DALI voltage supply 306. The DALI voltage supply 306 receives its supply voltage via the connections 311 and 312 of the radio suppression 305. The operating device also has a microprocessor 308 for DALI control and for evaluation of the signals received from the DALI interface 307. In a corresponding manner, the microprocessor 308 can also transmit signals to the DALI interface 307, for passing on via the DALI lines 301 and 302. The microprocessor 308 produces DALI signals which are evaluated via two lines E1 and E2 of an operating circuit 309. The operating circuit 309 is connected to the connections 311 and 312 of the radio suppression, and, on its output side, can operate a lamp 310 via connections L and N (line, neutral).

One possible implementation of the operating circuit 309 is shown by way of example in FIG. 4, and will be described in the following text.

As is shown in FIG. 3, the operating circuit 309 is connected to the connections 311 and 312 of the radio suppression 305. Furthermore, a galvanically isolated transmitter 401 in the operating circuit 309 receives the signals E1 and E2 from the microprocessor 308. The galvanically isolated transmitter 401 controls a power section 402 which is connected to the connections 311 and 312 of the radio suppression 305 and, on the output side, can control the lamp 310 via connections L and N.

The galvanically isolated transmitter 401 may be implemented in various ways. For example, in this case, it may be a transmission path between a light-emitting diode and a solar cell (for example in the form of an APV1122 component, photovoltaic MOSFET driver), an optocoupler or a magnetic transformer for mains frequencies.

When in the standby mode, the microprocessor 308 is supplied via the voltage supply 306. The operating circuit 309 is preferably configured such that it consumes less than 0.01 W when in a standby mode such as this. This has the advantage of a very low standby power with a full drive capability, wherein, in particular, the galvanically isolated transmitter 401 allows efficient control by means of DALI bus signals.

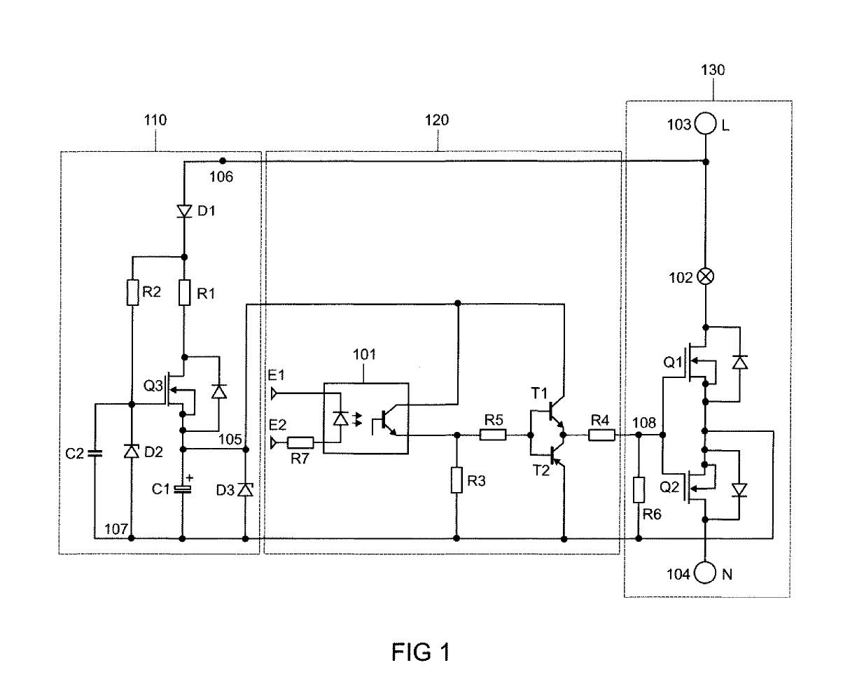

FIG. 1 shows an embodiment of the operating circuit 309 having a supply unit 110, a control 120 and the power section 402 which, in FIG. 1, is in the form of a power section 130.

The supply unit 110 has a diode D1, two resistors R1 and R2, two capacitors C1 and C2, two zener diodes D2 and D3 as well as an n-channel MOSFET Q3 with a diode between the drain connection and the source connection of the n-channel MOSFET Q3. The diode D1 prevents the capacitor C1 from being discharged via the diode of the MOSFET Q3, and therefore prevents the supply voltage from failing because the intermediate-circuit voltage can decrease to zero (the intermediate circuit follows the rectified AC voltage), and the capacitor C1 therefore being discharged.

The anode of the diode D1 is connected to a node 106, and the cathode of the diode D1 is connected via the resistor R1 to the drain connection of the MOSFET Q3. The cathode of the diode D1 is additionally connected via the resistor R2 to the gate connection of the MOSFET Q3. The gate connection of the MOSFET Q3 is also connected to the cathode of the zener diode D2 and, via the capacitor C2, to a node 107. The anode of the zener diode D2 is also connected to the node 107. The node 107 is a reference potential. The source connection of the MOSFET Q3 is connected to the node 107 via the capacitor C1, which is preferably an electrolytic capacitor. Furthermore, the source connection of the MOSFET Q3 is connected to a node 105, with the node 105 being connected to the cathode of the zener diode D3. The anode of the zener diode D3 is connected to the node 107.

The control 120 includes an optocoupler 101, inputs E1 and E2 (in this context, see the statements relating to FIG. 3 and FIG. 4), resistors R3, R4, R5 and R7 as well as an npn transistor T1 and a pnp transistor T2.

The connections E1 and E2 are connected to one another via the resistor R7 and the light-emitting diode of the optocoupler 101. The collector of the phototransistor of the optocoupler 101 is connected to the node 105, and the emitter of the phototransistor of the optocoupler 101 is connected via the resistor R3 to the node 107. In addition, the emitter of the phototransistor of the optocoupler 101 is connected via a resistor 105 to the base of the transistor T1 and to the base of the transistor T2 (the base connections of the transistors T1 and T2 are correspondingly connected to one another). The collector of the transistor T1 is connected to the node 105, and the emitter of the transistor T2 is connected to the node 107. Furthermore, the emitter of the transistor T1 is connected to the collector of the transistor T2, and via the resistor R4 to a node 108.

The power section 130 has a lamp 102, connections 103 (L connection), 104 (N connection), MOSFETs Q1 and Q2, and a resistor R6.

An (integrated) diode is arranged between the drain connection of the MOSFET Q1 and the source connection of the MOSFET Q1, with the cathode of the diode being connected to the drain connection. An (integrated) diode is likewise arranged between the drain connection of the MOSFET Q2 and the source connection of the MOSFET Q2, with the cathode of the diode being connected to the drain connection.

The node 108 is connected via the resistor R6 to the node 107. The node 108 is also connected both to the gate connection of the MOSFET Q1 and to the gate connection of the MOSFET Q2. The source connection of the MOSFET Q1 is connected to the source connection of the MOSFET Q2 and to the node 107. The drain connection of the MOSFET Q1 is connected via the lamp 102 to the node 106, which is in turn connected to the connection 103. The drain connection of the MOSFET Q2 is connected to the connection 104.

When the operating circuit 309 does not require any power (in the standby mode), that is to say when the lamp 102 is switched off, then the supply to the power section 130 via the MOSFET Q3 is switched off. Only a small amount of current is required for the gate connection of the MOSFET Q3. The resistor R2 may have a comparatively high resistance (in the region of a Megaohm). The supply unit 110 provides the control with a potential which is between the potentials required for controlling the MOSFETs Q1 and Q2.

Both in the standby mode and during active operation, the supply unit 110 always has the full mains voltage available to it. Because of the diode D1, only the positive half-cycle of the power supply is used.

The combination of the resistor R5 and the transistors T1 and T2 represents a so-called push-pull stage, which requires current only when it switches over. No current is accordingly required when no switching process is taking place. This is extremely efficient because the optocoupler 101 is fed via the microprocessor 308 (signals E1 and E2), and is switched off without the phototransistor in the optocoupler 101 being operated. The push-pull stage is accordingly not activated, and also does not require any current, when there is no intention of reacting to specific control signals from the microprocessor 308.

During operation, the lamp 102 can be controlled by means of signals via the lines E1 and E2. In this case, the brightness of the lamp can be adjusted by appropriate on-gating or off-gating phase control. The positive and the negative half-cycles can be used to control the lamp 102. Different sections, or any desired sections, of the respective phases can also be used to control the brightness (dimming) of the lamp 102.

In a corresponding manner, a corresponding control signal for dimming the lamp 310 or 102, respectively, can be passed from the DALI interface 307 to the microprocessor 308, via the DALI bus in the form of the DALI lines 301 and 302, where it is used to produce a corresponding control signal (for phase-gating control of the half-cycles), and can be transmitted via the lines E1, E2 to the operating circuit 309. A corresponding switch-off signal can also be detected in the same way by the operating device shown in FIG. 3, and is appropriately implemented by the microprocessor 308. As has been described above, the operating circuit requires only a very small current in the standby mode.

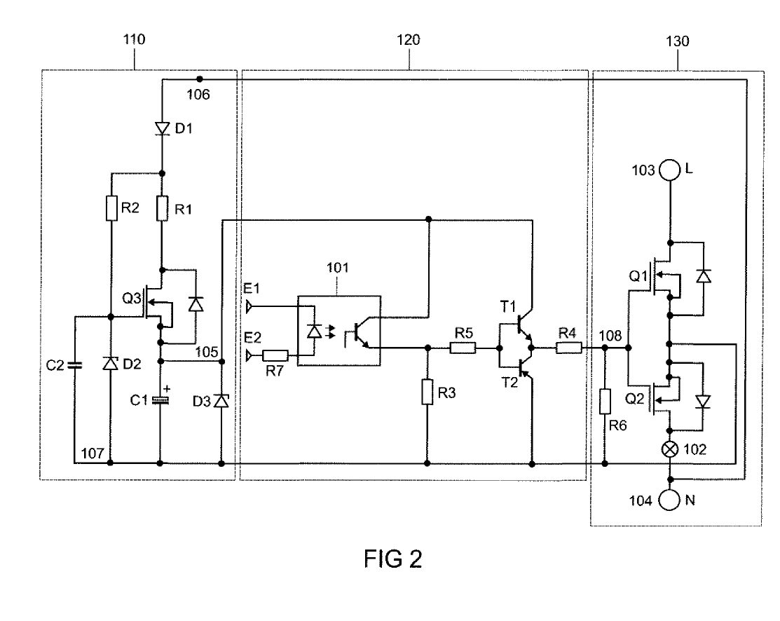

FIG. 2 shows an alternative circuit for the operating circuit 309, whose supply unit 110 and control 120 are identical to the corresponding components in FIG. 1.

The same components as those provided in the power section 130 shown in FIG. 1 are provided for the power section 130, although their connection differs, as follows: the drain connection of the MOSFET Q2 is connected via the lamp 102 to the node 106 and to the connection 104, and the drain connection of the MOSFET Q1 is connected to the connection 103.

One effect of the approach proposed here may be that the standby losses can be considerably reduced, and that simple control of the operating circuit, e.g. of the power section of the operating circuit, is proposed. In addition, the approach proposed here has good suppression capabilities.

Various embodiments may avoid or reduce the disadvantages mentioned above with respect to the prior art and may specify a circuit which can be used for controlling a lamp, and which consumes very little electrical power when it is inactive (e.g. in the standby mode).

In various embodiments, a circuit is specified for controlling an operating device for a light application, having a galvanically isolated transmitter to which a control signal can be applied; and having a power section which can be activated by the galvanically isolated transmitter as a function of the control signal.

This may allow the operating device to be controlled in a standby mode such that it requires only a very small amount of standby power. Particularly when no control signal is present, the power section can be effectively decoupled.

In various embodiments, it may be provided for the galvanically isolated transmitter to have at least one of the following components: an optocoupler; a photovoltaic driver; and a transformer.

By way of example, the optocoupler is a light-emitting diode, which transmits photons to a transistor, and thus switches the transistor on. By way of example, the photovoltaic driver has a light-emitting diode, which transmits photons to a solar cell and thus produces a voltage. In various embodiments, the transformer may be a magnetic transformer and/or a mains-frequency transformer.

The galvanically isolated transmitter may galvanically isolate the potential of the control signal from the potential of the power section. The control signal may correspond to a potential level of a processor unit (microprocessor), for example of a microprocessor which is provided for a DALI bus system. By way of example, the galvanically isolated transmitter is configured to inject or input control signals in the direction of the power section.

By way of example, the galvanically isolated transmitter may be part of a control system.

In various embodiments, the operating device has at least one of the following components or is in the form of at least one of the following components: a lamp or a light, in particular a light system; an electronic ballast; a transformer; an actuator; and/or a sensor.

The actuator may be a component (for example a switch) which carries out a predetermined action based on the control signal. In a corresponding manner, the sensor may provide the bus system with a signal as a control signal.

The electronic ballast may have a transformer for halogen lamps. The transformer may be a transformer for at least one halogen lamp.

By way of example, the operating device may therefore be a lamp with an integrated ballast and with a sensor for brightness detection.

In various embodiments, the operating device is configured to be dimmable, as a lamp, light, lamp system, ballast or having a plurality of the above-mentioned components.

In various embodiments, the control signal originates from a bus system, e.g. from a DALI bus system.

In various embodiments, the galvanically isolated transmitter and the power section are connected to a supply unit, wherein the supply unit has an electrical switch which switches off the power section in a standby mode, e.g. to a major extent.

The electronic switch (as well as any electronic switch mentioned here) may be in the form of a transistor, for example a bipolar transistor, a MOSFET, an IGBT or any other electrical switch.

Furthermore, in various embodiments, the galvanically isolated transmitter is connected to the power section via a push-pull stage.

For the purposes of various embodiments, the power section has at least two electronic switches which are controlled jointly and whose control links a load at least at times to a supply voltage.

By way of example, at least one lamp can therefore be dimmed by phase-gating control (for example in the form of on-gating and/or off-gating phase control).

In various embodiments, a brightness of at least one lamp can be controlled on the basis of the circuit.

In various embodiments, the brightness of the at least one lamp can be controlled by means of phase-gating control, in particular as a function of the control signal.

By way of example, the phase gating control is on-gating and/or off-gating phase control.

In various embodiments, the control signal can be produced by a microprocessor, wherein the microprocessor is connected to a bus system, e.g. via a bus interface.

In this case, it should be noted that the microprocessor may be any desired computer or processor with appropriate hardware and/or software (or firmware). The microprocessor may also be in the form of an FPGA or ASIC.

Furthermore, in various embodiments, an operating device may be provided having the circuit as described here, wherein the operating device may be configured to connect to a bus system, e.g. to a DALI bus system.

In various embodiments, the operating device is configured to control at least one lamp.

In various embodiments, the brightness of the at least one lamp can be adjusted via the bus system, or the at least one lamp can be deactivated, at least temporarily, via the bus system, e.g. on the basis of signals provided via the bus system.

In various embodiments, the operating device is in the form of a light or a light system.

Various embodiments may provide a method for operation of the circuit described herein, wherein at least one lamp is controlled or switched off by the control signal.

### LIST OF REFERENCE SYMBOLS

110 Supply unit
120 Control
130 Power section
101 Optocoupler
102 Lamp
103 L connection
104 N connection
105 to 108: respective node (points) in the circuit diagram
301 DALI (signal) line
302 DALI (signal) line
303 Power supply connection for supplying the operating device
304 Power supply connection for supplying the operating device
305 Radio suppression
306 DALI voltage supply
307 DALI interface
308 Microprocessor
309 Operating circuit
310 Lamp
311 Output from the radio suppression 305
312 Output from the radio suppression 305
401 Galvanically isolated transmitter
402 Power section.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A circuit for controlling an operating device for a light application, the circuit comprising:
a galvanically isolated transmitter configured to receive an applied control signal;
a power section configured to be activated by the galvanically isolated transmitter as a function of the control signal.

2. The circuit as claimed in claim 1,
wherein the galvanically isolated transmitter comprises at least one of the following components:
an optocoupler;
a photovoltaic driver; and
a transformer.

3. The circuit as claimed in claim 1,
wherein the operating device comprises at least one of the following components:
a lamp;
a light;
a light system;
an electronic ballast;
a transformer;
an actuator; and
a sensor.

4. The circuit as claimed in claim 1, further comprising:
a bus system configured to generate the control signal.

5. The circuit as claimed in claim 4,
wherein the us system comprises a DALI bus system.

6. The circuit as claimed in claim 1, further comprising:
a supply unit;
wherein the galvanically isolated transformer and the power section are connected to the supply unit;
wherein the supply unit comprises an electrical switch which switches off the power section in a standby mode.

7. The circuit as claimed in claim 1, further comprising:
a push-pull stage;
wherein the galvanically isolated transmitter is connected to the power section via the push-pull stage.

8. The circuit as claimed in claim 1,
wherein the power section comprises at least two electronic switches which are controlled jointly and whose control links a load at least at times to a supply voltage.

9. The circuit as claimed in claim 1,
wherein the circuit is configured to control a brightness of at least one lamp on the basis of the circuit.

10. The circuit as claimed in claim 9,
wherein the circuit is configured to control the brightness of the at least one lamp by means of phase-gating control

11. The circuit as claimed in claim 10,
wherein the circuit is configured to control the brightness of the at least one lamp by means of phase-gating control as a function of the control signal.

12. The circuit as claimed in claim 1, further comprising:
a microprocessor;
wherein the microprocessor is configured to generate the control signal;
wherein the microprocessor is connected to a bus system.

13. The circuit as claimed in claim 12,
a bus interface;
wherein the microprocessor is connected to a bus system via the bus interface.

14. An operating device, comprising:
a circuit for controlling an operating device for a light application, the circuit comprising:
a galvanically isolated transmitter configured to receive an applied control signal;
a power section configured to be activated by the galvanically isolated transmitter as a function of the control signal;
wherein the circuit is configured to connect to a bus system.

15. The operating device as claimed in claim 14,
wherein the circuit is configured to connect to a Digital Addressable Lighting Interface bus system.

16. The operating device as claimed in claim 14,
configured to control at least one lamp.

17. The operating device as claimed in claim 16,
configured such that the brightness of the at least one lamp can be adjusted via the bus system.

18. The operating device as claimed in claim 16,
configured such that the brightness of the at least one lamp can be deactivated, at least temporarily, via the bus system.

19. The operating device as claimed in claim 14,
wherein the operating device is in the form of selected from a group consisting of:
a light; and a light system.

20. A method for operation of a circuit for controlling an operating device for a light application,
the circuit comprising:
a galvanically isolated transmitter configured to receive an applied control signal;
a power section configured to be activated by the galvanically isolated transmitter as a function of the control signal;
the method comprising:
at least one of controlling and switching off at least one lamp by the control signal.
